(19) United States
(12) Patent Application Publication
(10) Pub. No.: US 2020/0290064 A1
(43) Pub. Date: Sep. 17, 2020

(54) MULTI-MODE HIGH-PRESSURE FOAM LANCE

(71) Applicant: Hangzhou Weirran Machinery Co., Ltd, Hangzhou (CN)

(72) Inventor: Qunwei JIA, Hangzhou (CN)

(21) Appl. No.: 16/400,682

(22) Filed: May 1, 2019

(30) Foreign Application Priority Data
Mar. 14, 2019 (CN) 201910194732.1

(51) Int. Cl. B05B 7/00; B05B 1/16

(52) U.S. Cl. CPC B05B 7/005; B05B 1/169

(57) ABSTRACT

The present invention provides a multi-mode high-pressure foam lance, which includes a foam-making component and a spray-mode component, wherein the foam-making component and the spray-mode component are connected through a sheath, the sheath is internally provided with an air mixing connecting tube, the spray-mode component includes a foam-making eccentric disc and a nozzle-mode rotary disc, an axis of the foam-making eccentric disc and an axis of the nozzle-mode rotary disc are fixedly connected through a positioning screw, a positioning pin is arranged between the foam-making eccentric disc and the nozzle-mode rotary disc, a spray hole of the foam-making eccentric disc is corresponding to a nozzle of the nozzle-mode rotary disc, and metallic foaming cotton is arranged between the foam-making eccentric disc and the air mixing connecting tube. The present invention has the advantages of reasonable structure design and multi-spray modes optimally matched with the foam-making component and convenient to switch, which greatly enriches the spray forms on the premise of optimizing a foam-making effect, and meets the requirements of user groups with different heights on covering and spraying foams on surfaces of various objects.

### TECHNICAL FIELD

The present invention relates to the technical field of jet apparatuses for foams made with soap lye, and more particularly, to a multi-mode high-pressure foam lance matched with a high-pressure washer.

### BACKGROUND

At present, a high-pressure foam lance realizes gradual switch of spraying foams from linear spray to sector spray by rotating a plastic sheath to change an opening degree of a stainless-steel spray sheet. The spray mode is relatively simple and cannot fully meet the personalized requirements of users in use. Moreover, the users need more spray modes convenient to switch so as to meet the actual use requirements when using the high-pressure foam lance.

Since the spray mode directly affects a flow velocity, a flow amount, a fluid direction, etc., of fluid in a foam-making component, a suction volume of soap lye and a mixing ratio with air may be affected, which directly affects the foam-making effect. Therefore, the rich diversification of the spray mode is always a technical difficulty. At present, there is no high-pressure foam lance that has more spray modes and is easy to switch so as to better meet the needs of the users.

### SUMMARY

The present invention is intended to provide a multi-mode high-pressure foam lance with reasonable structure design and multi-spray modes optimally matched with the foam-making component and convenient to switch.

In order to achieve the object above, the following technical solutions are used in the present invention.

A multi-mode high-pressure foam lance includes a foam-making component and a spray-mode component, a sheath is arranged between the foam-making component and the spray-mode component, the foam-making component and the spray-mode component are connected through an air mixing connecting tube arranged in the sheath, the spray-mode component includes a foam-making eccentric disc and a nozzle-mode rotary disc, an axis of the foam-making eccentric disc and an axis of the nozzle-mode rotary disc are fixedly connected through a positioning screw, a positioning pin with a spring is arranged between the foam-making eccentric disc and the nozzle-mode rotary disc, a spray hole of the foam-making eccentric disc is corresponding to a nozzle of the nozzle-mode rotary disc, and metallic foaming cotton is arranged between the foam-making eccentric disc and the air mixing connecting tube.

Further, the nozzle-mode rotary disc is provided with a vertical fan-shaped nozzle, a horizontal fan-shaped nozzle, a conical nozzle, a press-down nozzle and a linear nozzle.

Further, the foam-making component is sequentially connected with a soap lye bottle, a suction pipe, a connecting piece, a bottle cap, a four-way valve body, an adjusting valve and an adjusting knob from bottom to top, the adjusting knob is fixed on the adjusting valve through a screw, the four-way valve body is internally provided with a high-pressure throttling nozzle, a left end of the four-way valve body is connected with the air mixing connecting tube; a right end of the four-way valve body is connected with a quick connector, an upper end of the four-way valve body is connected with the adjusting valve, a lower end of the four-way valve body is connected with the connecting piece for sucking soap lye, one end of the suction pipe extends into soap lye in the soap lye bottle, and the other end of the suction pipe is connected with the connecting piece.

Further, the adjusting knob drives the adjusting valve to displace up and down to form an air gap between the adjusting valve and the four-way valve.

Compared with the prior art, the present invention has the following advantages.

The multi-mode high-pressure foam lance according to the present invention has the advantages of reasonable structure design and multi-spray modes optimally matched with the foam-making component and convenient to switch, which greatly enriches the spray forms on the premise of optimizing a foam-making effect, and meets the requirements of user groups with different heights on covering and spraying foams on surfaces of various objects.

### BRIEF DESCRIPTION OF THE DRAWINGS

FIG. 1 is a structure diagram of a multi-mode high-pressure foam lance according to the present invention.

FIG. 2 is a structure diagram of a nozzle-mode rotary disc of the multi-mode high-pressure foam lance according to the present invention.

FIG. 3 is a diagram of a spray shape of a vertical fan-shaped nozzle of the multi-mode high-pressure foam lance according to the present invention.

FIG. 4 is a diagram of a spray shape of a horizontal fan-shaped nozzle of the multi-mode high-pressure foam lance according to the present invention.

FIG. 5 is a diagram of a spray shape of a conical nozzle of the multi-mode high-pressure foam lance according to the present invention.

FIG. 6 is a diagram of a spray shape of a press-down nozzle of the multi-mode high-pressure foam lance according to the present invention.

FIG. 7 is a diagram of a spray shape of a linear nozzle of the multi-mode high-pressure foam lance according to the present invention.

FIG. 8 is a diagram illustrating a connecting structure of a foam-making eccentric disc and a nozzle-mode rotary disc of the multi-mode high-pressure foam lance according to the present invention.

FIG. 9 is a side view of the foam-making eccentric disc of the multi-mode high-pressure foam lance according to the present invention.

FIG. 10 is a front view of the foam-making eccentric disc of the multi-mode high-pressure foam lance according to the present invention.

FIG. 11 is a side view of the nozzle-mode rotary disc of the multi-mode high-pressure foam lance according to the present invention.

FIG. 12 is a front view of the nozzle-mode rotary disc of the multi-mode high-pressure foam lance according to the present invention.

FIG. 13 is a structure diagram of a four-way valve of the multi-mode high-pressure foam lance according to the present invention.

FIG. 14 is a diagram illustrating a suction structure of soap lye of the multi-mode high-pressure foam lance according to the present invention.

Reference numerals: 1 refers to soap lye bottle, 2 refers to suction pipe, 3 refers to connecting piece, 4 refers to bottle cap, 5 refers to four-way valve body, 6 refers to adjusting valve, 7 refers to adjusting knob, 8 refers to high-pressure throttling nozzle, 9 refers to air mixing connecting tube, 10 refers to quick connector, 11 refers to sheath, 12 refers to foam-making eccentric disc, 13 refers to nozzle-mode rotary disc, 14 refers to positioning pin, 15 refers to metallic foaming cotton, 16 refers to positioning screw, and 17 refers to sealing ring.

### DETAILED DESCRIPTION

The embodiments of the present invention are further described in detail hereinafter with reference to the drawings.

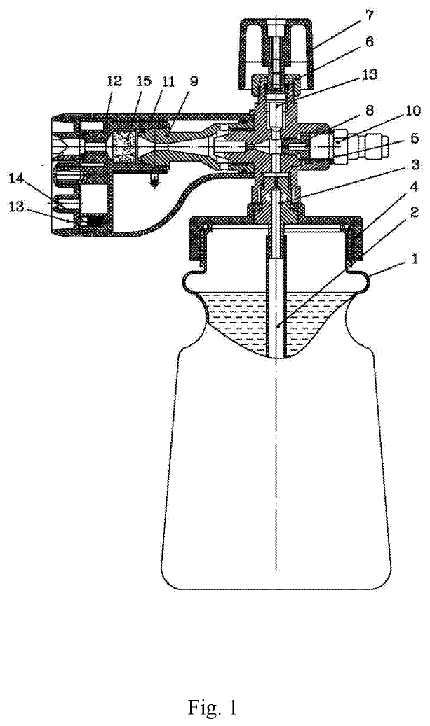

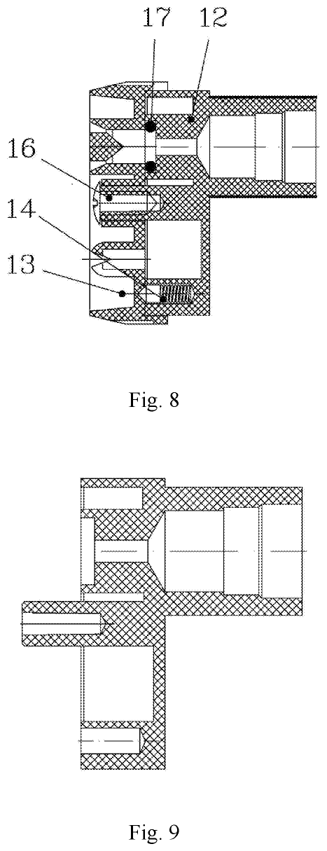

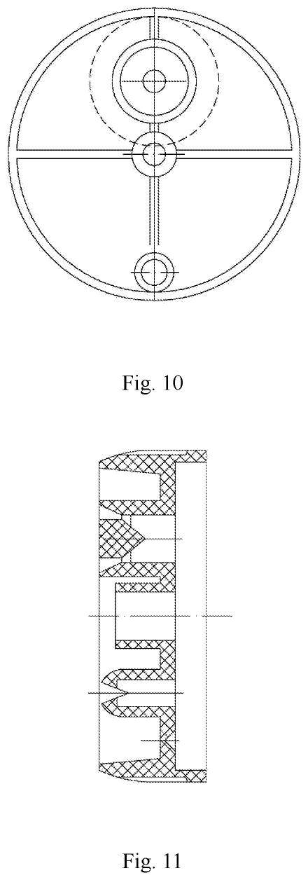

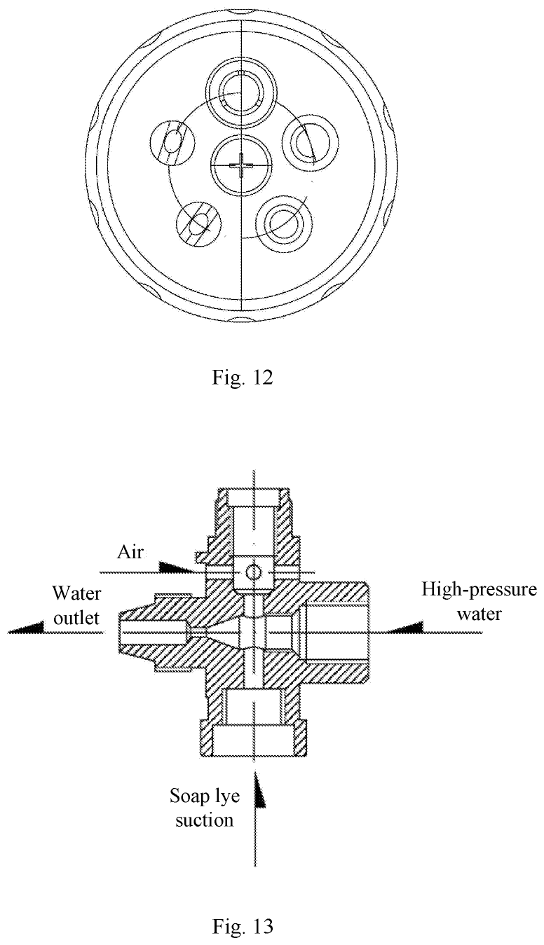

As shown in FIG. 1, a multi-mode high-pressure foam lance includes a foam-making component and a spray-mode component, wherein a sheath 11 is arranged between the foam-making component and the spray-mode component, and the foam-making component and the spray-mode component are connected through an air mixing connecting tube 9 arranged in the sheath 11. The foam-making component is sequentially connected with a soap lye bottle 1, a suction pipe 2, a connecting piece 3, a bottle cap 4, a four-way valve body 5, an adjusting valve 6 and an adjusting knob 7 from bottom to top, and the adjusting knob 7 is fixed on the adjusting valve 6 through a screw. As shown in FIG. 13, the four-way valve body 5 is internally provided with a high-pressure throttling nozzle 8, a left end of the four-way valve body 5 is connected with the air mixing connecting tube 9, a right end of the four-way valve body 5 is connected with a quick connector 10, an upper end of the four-way valve body 5 is connected with the adjusting valve 6, a lower end of the four-way valve body 5 is connected with the connecting piece 3 for sucking soap lye, and the quick connector 10 is communicated with the high-pressure throttling nozzle 8. One end of the suction pipe 2 extends into soap lye in the soap lye bottle 1, and the other end of the suction pipe 2 is connected with the connecting piece 3. As shown in FIGS. 8, 9, 10, 11 and 12, the spray-mode component includes a foam-making eccentric disc 12 and a nozzle-mode rotary disc 13, and the foam-making eccentric disc 12 and the nozzle-mode rotary disc 13 are fixedly connected through a positioning screw 16 after being matched and positioned through an axial hole; in order to prevent water leakage from being increased after the two parts are joined, a sealing ring 17 is arranged at a joint of a spray hole of the foam-making eccentric disc 12 and a nozzle of the nozzle-mode rotary disc 13; in order to accurately position the nozzle-mode rotary disc 13 when rotating, a positioning pin 14 with a spring is arranged between the foam-making eccentric disc 12 and the nozzle-mode rotary disc 13; and a groove at a rear side of the foam-making eccentric disc 12 is clamped with the air mixing connecting tube 9, and metallic foaming cotton 15 is arranged in the groove at the rear side of the foam-making eccentric disc 12.

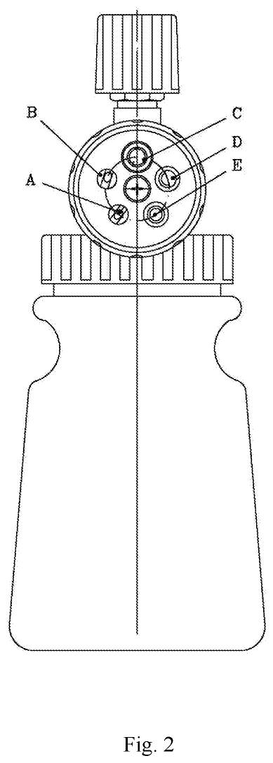

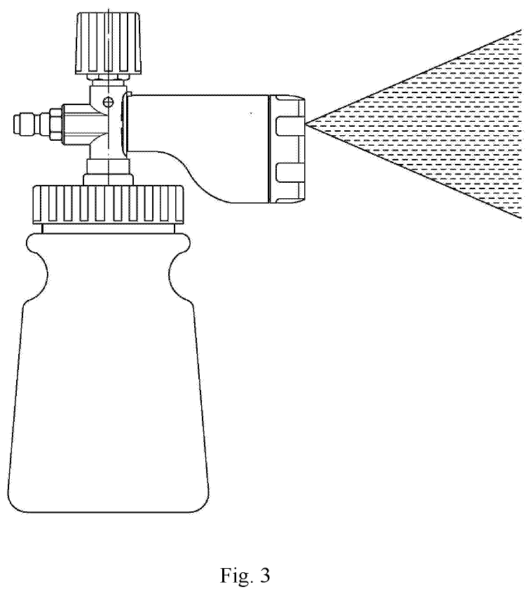

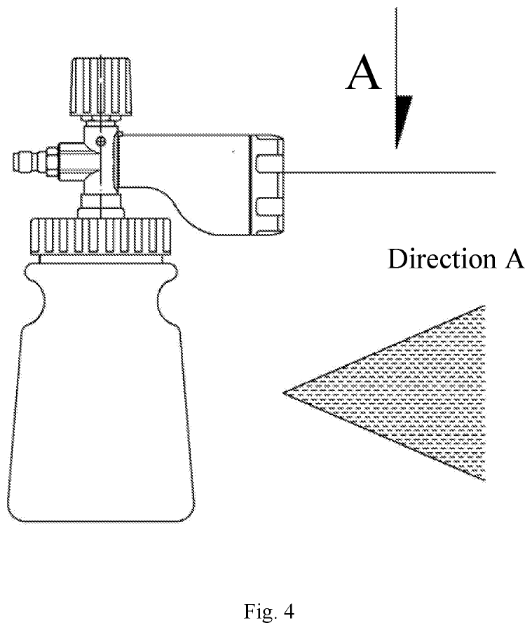

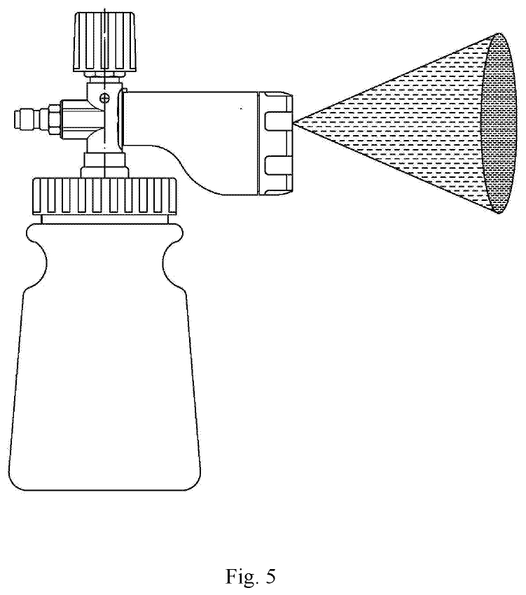

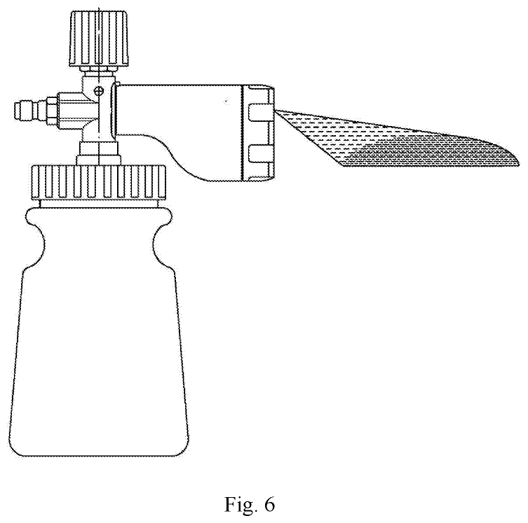

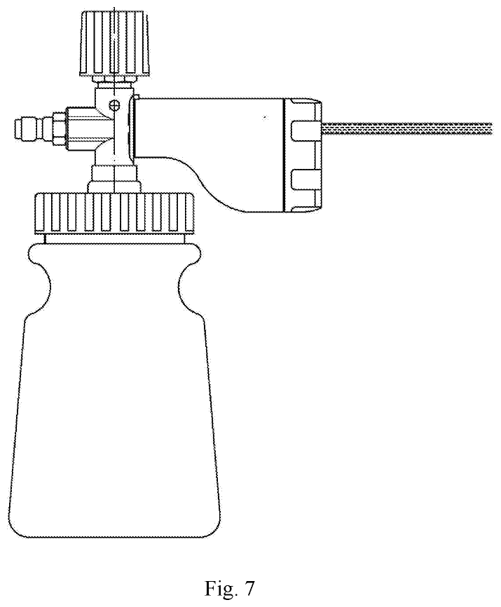

As shown in FIG. 2, the nozzle-mode rotary disc is provided with A. a vertical fan-shaped nozzle, B. a horizontal fan-shaped nozzle, C. a conical nozzle, D. a press-down nozzle and E. a linear nozzle. As shown in FIG. 3, A. the vertical fan-shaped nozzle is characterized in that the vertical fan-shaped nozzle may cover a larger spraying surface by swinging left and right and is suitable for a wider surface or a surface with a longer horizontal distance. As shown in FIG. 4, B. the horizontal fan-shaped nozzle is characterized in that the horizontal fan-shaped nozzle may cover a larger spraying surface by swinging up and down and is suitable for a surface of a higher object. As shown in FIG. 5, C. the conical nozzle is characterized in that the conical nozzle has a large spraying coverage surface and is suitable for a large-area and irregularly shaped object surface or a large-area ground surface. As shown in FIG. 6, D. the press-down nozzle is characterized in that the press-down nozzle may cover the spraying surface by swinging left and right and is suitable for spraying a horizontal top surface of an object, such as a vehicle roof. As shown in FIG. 7, E. the linear nozzle is characterized in that the linear nozzle has a large impact force, may directly wash dirt, and is suitable for uneven object, crevice, dead angle and other scenes.

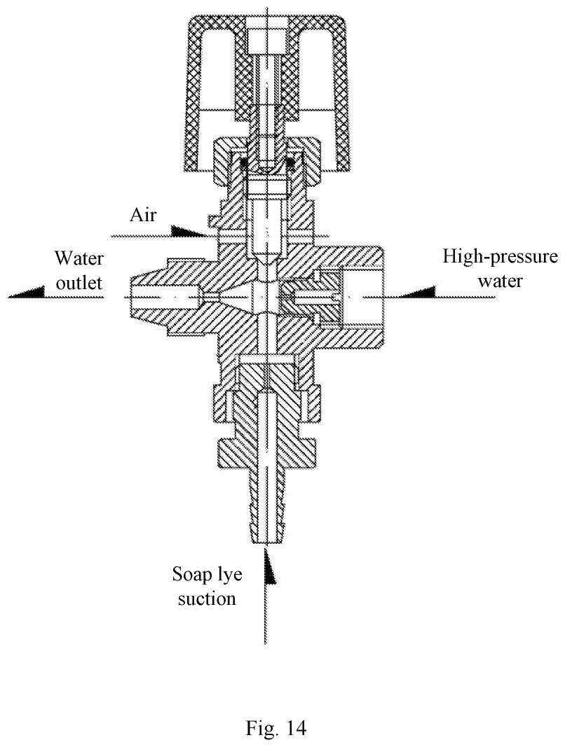

As shown in FIG. 14, the adjusting knob 7 drives the adjusting valve 6 to displace up and down to form an air gap between the adjusting valve 6 and the four-way valve 5. When the adjusting valve 6 moves upwardly, the valve is opened to allow air to enter; and when the adjusting valve 6 moves downwardly, the valve is closed to isolate from the air. When the adjusting knob 7 rotates clockwise, the adjusting valve 6 moves downwardly, and a gap between the adjusting valve 6 and the four-way valve 5 is slowly narrowed. At the moment, a vacuum degree in the four-way valve 5 is gradually increased, and soap lye is sucked into the four-way valve 5 under an action of negative pressure. With the increase of the vacuum degree, a suction force is also increased, so that a suction volume of the soap lye is increased, which is vice versa.

As shown in FIG. 13, the soap lye is mixed with high-pressure water communicated with the quick connector 10 after being sucked into the four-way valve 5, and then is sprayed out through a high-pressure throttling nozzle 8 arranged in the four-way valve body 5.

The specific steps for operating the multi-mode high-pressure foam lance according to the present invention are as follows:

(1) adding a liquid mixed by the soap lye and clear water in proportion into the soap lye bottle 1, and screwing the bottle cap 4 of the soap lye bottle 1 tightly;

(2) sequentially assembling and connecting various parts of the foam-making component and the spray-mode component;

(3) connecting a high-pressure water lance or a high-pressure washer lance with the quick connector 10;

(4) rotating the nozzle-mode rotary disc 13 to select a required nozzle mode, being corresponding to the spray hole of the foam-making eccentric disc 12, and at the moment, sensing a sound of accurately positioning the positioning pin 14;

(5) rotating the adjusting knob 7 to drive the adjusting valve 6 to move up and down, wherein a suction volume of the soap lye is the largest when the adjusting knob 7 is clockwise rotated to a bottom, otherwise the suction volume of the soap lye is the smallest; and

(6) turning on a switch of the high-pressure water lance or a switch of the high-pressure washer to aim the foam lance at a surface of a target spray object after a high-pressure pump reaches a rated pressure range, high-pressure clear water entering the four-way valve body 5, at the moment, sucking the soap lye into the four-way valve body 5 through the suction pipe 2 and the connecting piece 3, mixing with the high-pressure clear water, spraying out the mixed liquid through the high-pressure throttling nozzle 8 in the four-way valve body 5, mixing the mixed liquid with air through an air mixing connecting sheath 9, then spraying out through a conical spray hole at the tail end, foaming the mixed liquid after hitting the metallic foaming cotton 15 at a high speed, and finally spraying to the surface of the target object through a certain nozzle selected on the foam-making eccentric disc 12 and the nozzle-mode rotary disc 13.

The foregoing is merely the preferred embodiment of the present invention, and it should be noted that those of ordinary skills in the art may further make a plurality of improvements and decorations without departing from the principle of the present invention, and these improvements and decorations shall also fall within the protection scope of the present invention.

1. A multi-mode high-pressure foam lance, comprising a foam-making component and a spray-mode component, a sheath being arranged between the foam-making component and the spray-mode component, and the foam-making component and the spray-mode component being connected through an air mixing connecting tube arranged in the sheath, wherein the spray-mode component comprises a foam-making eccentric disc and a nozzle-mode rotary disc, an axis of the foam-making eccentric disc and an axis of the nozzle-mode rotary disc are fixedly connected through a positioning screw, a positioning pin with a spring is arranged between the foam-making eccentric disc and the nozzle-mode rotary disc, a spray hole of the foam-making eccentric disc is corresponding to a nozzle of the nozzle-mode rotary disc, and metallic foaming cotton is arranged between the foam-making eccentric disc and the air mixing connecting tube.

2. The multi-mode high-pressure foam lance according to claim 1, wherein the nozzle-mode rotary disc is provided with a vertical fan-shaped nozzle, a horizontal fan-shaped nozzle, a conical nozzle, a press-down nozzle and a linear nozzle.

3. The multi-mode high-pressure foam lance according to claim 1, wherein the foam-making component is sequentially connected with a soap lye bottle, a suction pipe, a connecting piece, a bottle cap, a four-way valve body, an adjusting valve and an adjusting knob from bottom to top, the adjusting knob is fixed on the adjusting valve through a screw, the four-way valve body is internally provided with a high-pressure throttling nozzle, a left end of the four-way valve body is connected with the air mixing connecting tube, a right end of the four-way valve body is connected with a quick connector, an upper end of the four-way valve body is connected with the adjusting valve, a lower end of the four-way valve body is connected with the connecting piece for sucking soap lye, one end of the suction pipe extends into soap lye in the soap lye bottle, and the other end of the suction pipe is connected with the connecting piece.

4. The multi-mode high-pressure foam lance according to claim 3, wherein the adjusting knob drives the adjusting valve to displace up and down to form an air gap between the adjusting valve and the four-way valve.
